(19) United States
(12) Patent Application Publication
(10) Pub. No.: US 2015/0290780 A1
(43) Pub. Date: Oct. 15, 2015

(54) MULTI-PURPOSE WRENCH FOR SERVICING A FIREARM

(71) Applicant: Magpul Industries Corp., Boulder, CO (US)

(72) Inventors: William Bradley Bennett, Lafayette, CO (US); Michael T. Mayberry, Denver, CO (US); Jeremy Fiester, Lafayette, CO (US); Lance Johnston, Firestone, CO (US); Jonathan Cross, Longmont, CO (US); Brian L. Nakayama, Arvada, CO (US)

(21) Appl. No.: 14/687,458

(22) Filed: Apr. 15, 2015

Related U.S. Application Data
(60) Provisional application No. 61/979,926, filed on Apr. 15, 2014.

(51) Int. Cl. B25B 13/50; F41A 35/00; B25B 13/06

(52) U.S. Cl. CPC B25B 13/50; B25B 13/065; F41A 35/00

(57) ABSTRACT

A wrench and a method for performing gunsmithing operations is disclosed. The wrench may have a first end and a second end. The first end may have an integrated two-sided castle nut and flash hider wrench aperture, and the second end may have a tool interface. The aperture may have a plurality of raised elements for engaging indentations in a castle nut, each of the raised elements extending at least one of inwardly from a wall section of the aperture and upwardly from a first face of the wrench. The aperture may have a flash hider cutout portion.

### CROSS-REFERENCE TO RELATED APPLICATIONS

This application claims benefit to U.S. Provisional Application No. 61/979,926 filed Apr. 15, 2014 and entitled “MULTI-PURPOSE WRENCH FOR SERVICING A FIREARM,” the entire disclosure of which is hereby incorporated by reference for all purposes, as if fully set forth herein.

### FIELD OF THE DISCLOSURE

The present disclosure relates generally to gunsmithing and more particularly to a multi-purpose wrench for servicing a firearm.

### BACKGROUND OF THE INVENTION

Users of military and civilian AR15/M16 or M4 type weapons have numerous accessory options for customizing, repairing, and enhancing these firearms. Such accessories include barrels, flash hiders, sling attachments, handguards, rails, sights, and stocks, among others. Installation of some or all of these accessories or replacement components requires several specifically shaped tools in order to remove and later reengage integral attachments such as barrel nuts, castle nuts, and flash hiders, each of which can be notoriously difficult to remove and should be tightly reengaged so that firing vibration and handling does not jar these components loose. Users, such as professional gunsmiths and hobbyists, looking to remove or reengage a barrel nut, castle nut, or flash hider, require a tool able to apply a great deal of torque. Wrenches can provide high torque when a component aperture is located on an end of an elongate wrench. Previous wrench designs have combined a barrel nut aperture on one end and a castle nut aperture on another end, and sometimes have included a flash hider aperture somewhere between the two ends. However, such designs deliver less torque to the flash hider than if the flash hider aperture were arranged on an end of the wrench. This challenge can be solved via use of a torque extender or a dedicated flash hider wrench, but this also entails the carrying of multiple tools, which is disadvantageous to military personnel in the field. Moreover, certain accessory end plates can significantly limit the utility of certain castle nut wrenches.

Thus, there exists a need for a wrench that can remedy the foregoing problems.

### SUMMARY

The present disclosure relates generally to a wrench having apertures for removing and attaching particular components of an AR15/M16 type rifle or M4 type carbine, such as a castle nut, a flash hider, and a barrel nut.

In some aspects, a wrench for performing gunsmithing operations is provided, having a first end and a second end. The first end may have an aperture having a first castle nut interface shaped to engage a castle nut, a second castle nut interface shaped to engage the castle nut, and a flash hider interface. The first castle nut interface may have a substantially cylindrical wall section shaped to surround a portion of an outer surface of the castle nut, the cylindrical wall section having a plurality of raised elements extending inwardly for engaging a plurality of indentations in the castle nut. The second castle nut interface may have a substantially flat face, the flat face having a plurality of protrusions extending from the flat face for engaging the plurality of indentations in the castle nut.

In some aspects, a wrench for performing gunsmithing operations is provided, having a first end having an integrated two-sided castle nut and flash hider wrench aperture. The aperture may have a plurality of raised elements for engaging indentations in a castle nut, each of the raised elements extending at least one of inwardly from a wall section of the aperture and upwardly from a first face of the wrench. The aperture may also have a flash hider cutout portion. The wrench may have a second end with a tool interface.

In some aspects, a wrench for performing gunsmithing operation is provided, having a first end with an aperture and a second end. The aperture may extend through two faces of the wrench and have a plurality of raised elements for engaging indentations in a castle nut. The raised elements may extend at least one of inwardly from a substantially cylindrical wall section of the aperture and outward from one of the two faces of the wrench. The aperture may have a flash hider interface having two opposing walls.

### BRIEF DESCRIPTION OF THE DRAWINGS

FIG. 1 is a front perspective view of one side of an integrated two-sided castle nut and flash hider aperture for a wrench.

FIG. 2 is an opposing perspective view of the aperture of FIG. 1.

FIG. 3 is a front perspective view of the aperture of FIG. 1 engaged with a flash hider.

FIG. 4 is a rear perspective view of the aperture of FIG. 1 engaged with a flash hider.

FIG. 5 is a rear perspective view of the aperture of FIG. 1 on a wrench, engaged with a castle nut on a weapon.

FIG. 6 is a close up, rear perspective view of the aperture engaged as in FIG. 5, showing the castle nut and end plate.

FIG. 7 is a close up, bottom perspective view of the aperture engaged as in FIG. 6, showing the aperture engaged with the castle nut.

FIG. 8 is a close up, front perspective view of the aperture as engaged in FIG. 5, particularly showing a flush engagement with the end plate.

FIG. 9 is a front perspective view of the aperture engaged with a castle nut along with some components of a weapon.

FIG. 10 is a side view of the aperture as engaged in FIG. 9.

FIG. 11 is a rear perspective view of the aperture as engaged in FIG. 9, showing the castle nut and the accessory adapter end plate.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

The present disclosure relates generally to a multi-purpose wrench for servicing a firearm. In particular, but not by way of limitation, the present disclosure relates to systems, methods and apparatuses for a wrench having apertures for removing and attaching particular components of an AR15/M16 type rifle or M4 type carbine, such as a castle nut, a flash hider, and a barrel nut, the apertures being optimally positioned for maximum torque at each element to be removed or attached.

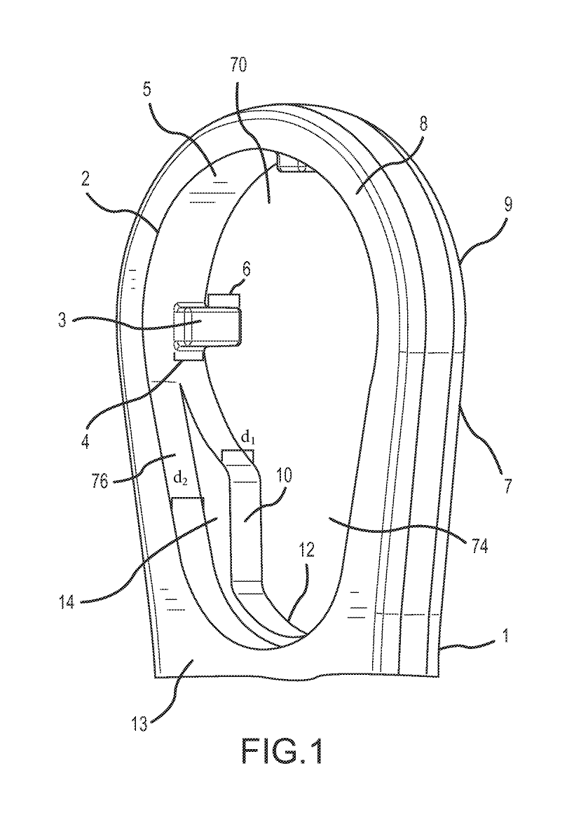

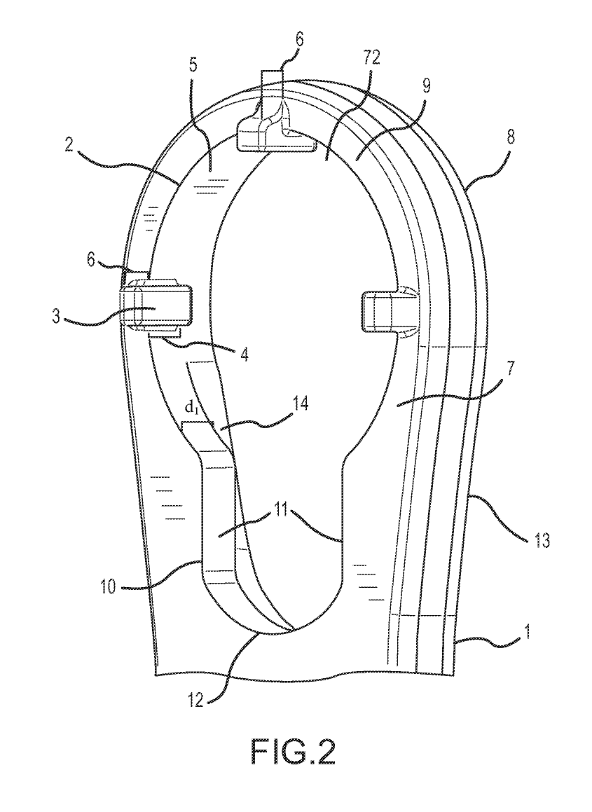

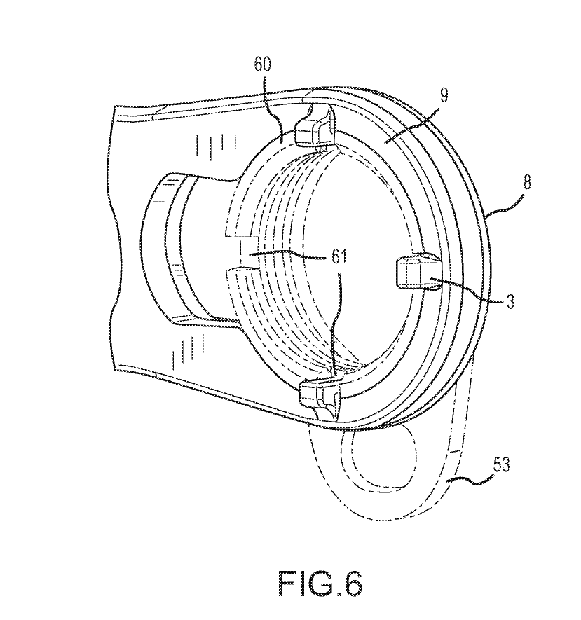

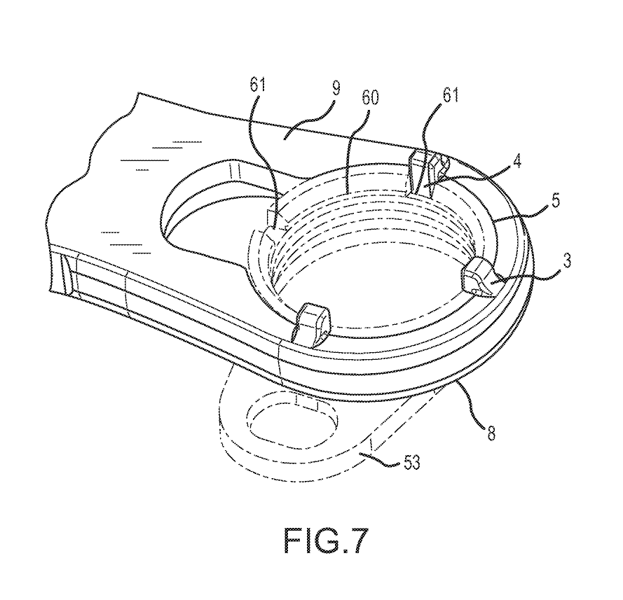

Referring to FIGS. 1 and 2, shown is a wrench body 1 containing an integrated two-sided castle nut and flash hider wrench aperture 2, which may be referenced herein simply as an “aperture.” The aperture 2 comprises a plurality of prongs 3 that are sized to fit within the four indentations 61 of castle nut 60, as seen in FIG. 6. The prongs 3 each have a raised element 4 which is affixed to an aperture socket interior 5 (see e.g. FIG. 7). The prongs 3 each also have protruding sections 6 which protrude beyond the aperture socket interior 5, and are substantially perpendicular to a face 7 of the aperture 2. For reasons that will become apparent later in the disclosure, the sides of the aperture 2 are referred to herein as surround side 8 and protrusion side 9. Alternatively, they may be referred to as a front side 8 and a back side 9. The front side 8 has a face 13 and the back side 9 has a face 7.

A first castle nut interface 70 is most clearly illustrated in FIG. 1. The first castle nut interface 70 may have a substantially cylindrical wall section shaped to surround a portion of an outer surface of the castle nut, with the cylindrical wall section having a number of prongs 3 or raised elements 4 extending inwardly for engaging a number of indentations in the castle nut. A second castle nut interface 72 is illustrated most clearly in FIG. 2. The second castle nut interface 72 may have a substantially flat face such as face 7, with a number of prongs 3 or protrusions, such as protruding sections 6, extending from the flat face for engaging a number of indentations in the castle nut. In some embodiments, raised elements 4, prongs 3, and protruding sections 6 may be formed by a unitary feature.

It should also be understood that, although the raised elements 4, prongs 3, and protruding sections 6 are all located at the same orientation, in some embodiments, the protruding sections 6 may be “rotated” relative to the raised elements 4. That is, the protruding sections 6 may extend from the wrench at different points than do the raised elements 4. It should also be understood that although sets of three each are illustrated, it is not required that the wrench have an equal number of sets. For example, the wrench may have two raised elements 4 and three protruding sections 6, or vice versa, or any suitable number of raised elements 4, prongs 3, and/or protruding sections 6.

Still referring to FIGS. 1 and 2, the aperture 2 has a flash hider cutout section 10 that is shaped and sized to fit a flash hider which is comprised of flat sections 11 and rounded section 12. The distance between the flat sections 11 is approximately 0.75 inches, which is a standard size for commercially available flash hiders, but can comprise any distance needed to fit a given non-standard flash hider, muzzle break, blast diffuser, sound suppressor, other muzzle accessories and/or other calibers. The rounded section 12 is designed to closely engage a third side of a flash hider, providing additional contact surface area as compared to a standard wrench or a flash hider wrench without such a rounded section. It should be understood that the rounded section 12 need not extend completely between each of the flat sections 11. For example, in some embodiments, the flash hider may engage the flash hider cutout section 10 at two walls and a rounded section, with gaps between the engagements with these features.

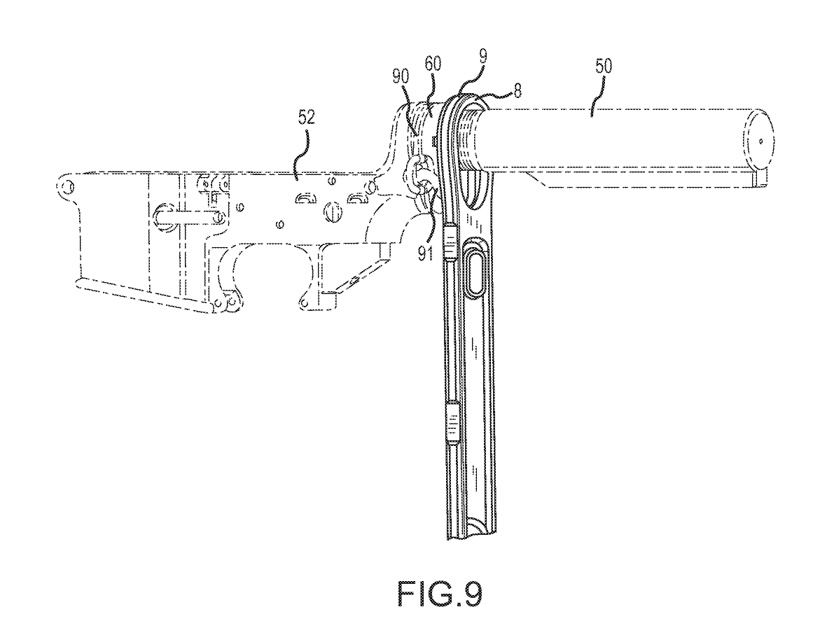

An additional benefit of the width between the flat sections 11 is that it is greater than the width of a rectangular longitudinal protrusion 51 on a buffer tube or receiver extension 50 seen in FIG. 9. The flash hider cutout section 10, therefore, allows for the aperture 2 to slide over the receiver extension 50 without hindrance from the rectangular protrusion at a bottom of the receiver extension 50. Cutouts that enable the user to slide wrenches over receiver extensions are known in the art. However, no known cutouts are designed to both slide over the rectangular protrusion at a bottom of the receiver extension 50 and to couple to a flash hider.

Still referring to FIGS. 1 and 2, in some embodiments, the flash hider cutout 10 is flush with the face 7 of the protrusion side 9. On the surround side 8, there is an optional recessed step 14 between the face 13 and the flash hider cutout 10. The optional recessed step 14 can accommodate various flash hider designs. For example, some flash hiders have diameters abutting the flat surfaces that are greater than the width of the circular surfaces on both sides of the flat surfaces.

In some embodiments, the recessed step 14 provides a receiver end plate interface designed to drive a carbine receiver extension. To give the reader some background, it is noted that the carbine receiver extension, the receiver end plate (which is keyed to the receiver extension), and the castle nut are installed and/or removed as a group as the extension is threaded into the receiver. While this can usually be done by hand, there are occasions in which additional torque may be required. In those cases, a user can cause the recessed step 14 to engage the receiver end plate to rotate the group of three parts into place. Additionally, most flash hiders have flat engagement areas that are not as far apart from each other as the diameter of other portions of the flash hider. The recessed step 14 provides clearance for the greater diameter sections of such flash hiders while providing an appropriate width between the flat sections 11 to engage the flash hider.

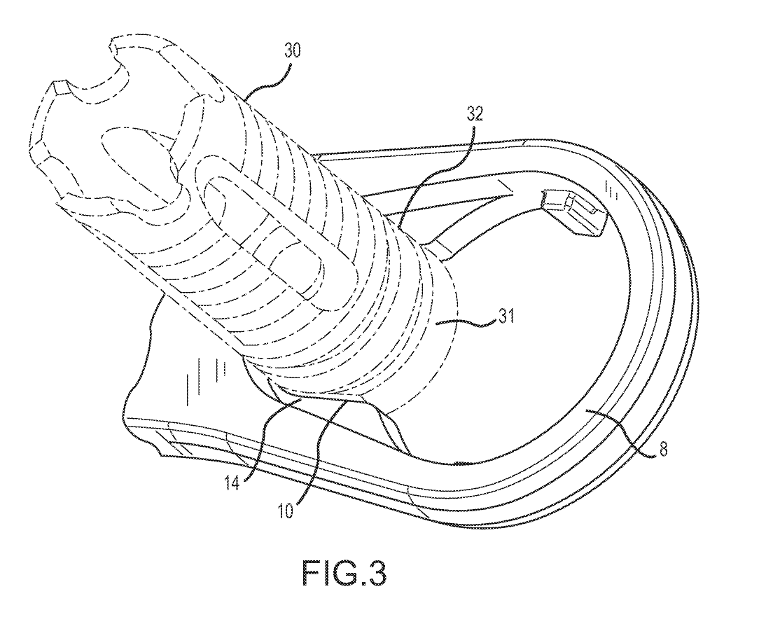

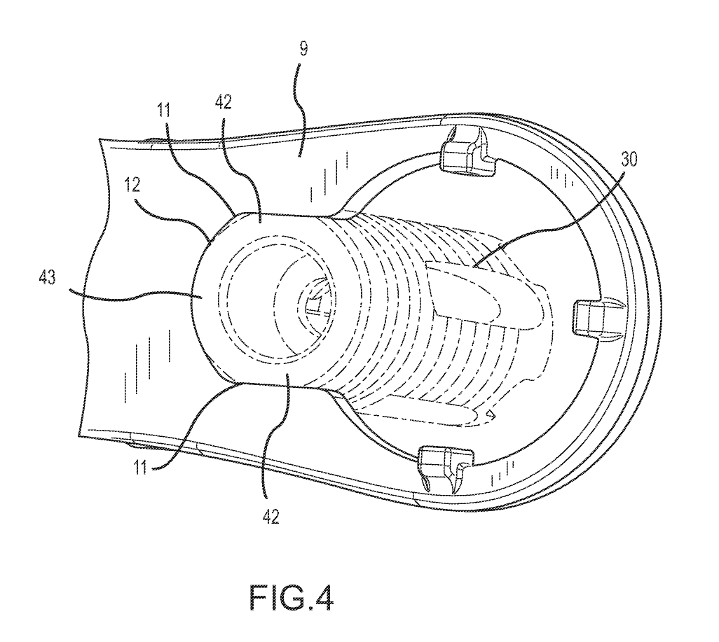

FIGS. 3 and 4 show opposing views of the aperture 2 engaged with a flash hider 30 via the flash hider cutout 10. The flash hider 30 in these figures has flat engagement edges 42 and round engagement edge 43. The flat engagement edges 42 engage with the flat sections 11, and the round engagement edge 43 engages with the rounded section 12, so the flash hider 30 is engaged on three edges. This is preferable to engaging a flash hider on only two edges and prevents slipping. In the illustrated embodiment, the flash hider 30 also has flat engagement edge width 31 that is approximately the same width as flash hider cutout 10, although this width is not required. In other embodiments, the width of the flash hider cutout 10 can be greater or less than the flat engagement edge width 31. In the illustrated embodiment, the flash hider 30 also has a diameter 32 that is slightly wider than the 0.75″ width of flash hider cutout 10 on the side that is pointed toward the surround side 8. That is, the diameter 32 is slightly greater that the distance between the outermost edges of the two flat engagement edges 42. Also in the illustrated embodiment, this diameter 32 only exists on one side of flat engagement edges 42—on the side pointed toward front side 8. It is to be understood that other types of flash hiders have diameters wider than 0.75″ on both sides of flat engagement edges 42 along the longitudinal axis of the flash hider 30, i.e., on the sides pointing towards the front side 8 and the back side 9, which is one reason that the recessed step 14 is beneficial.

Continuing with FIGS. 1-4, the aperture 2 may have a flash hider interface 74. The flash hider interface 74 may have a flash hider cutout section 10 that extends from one of the faces 7, 8 to a first depth of a stepped passage, and a clearance portion 76 extending from the flash hider cutout section 10 through the other one of the faces 7, 8. In some embodiments, the flash hider cutout section 10 may extend all the way through the wrench, from one face 7, 8 through another face 7, 8.

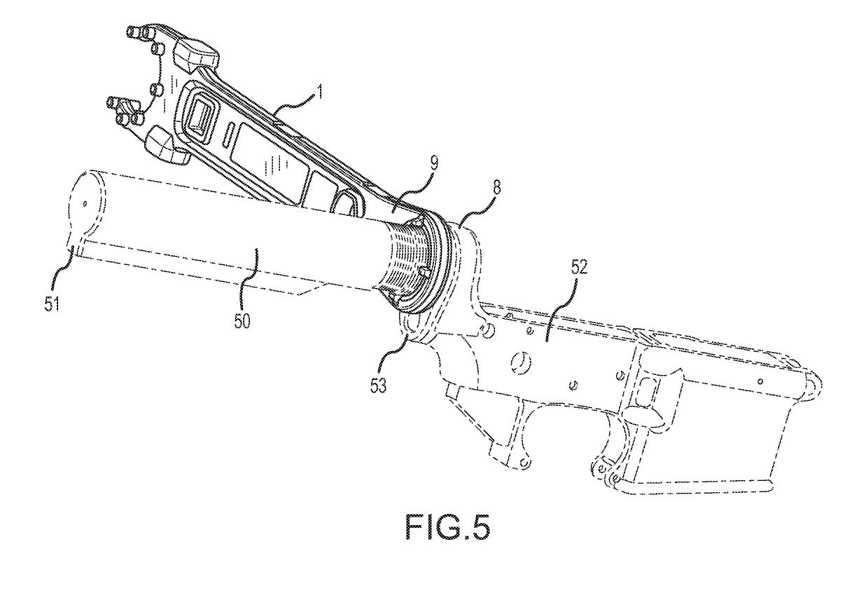

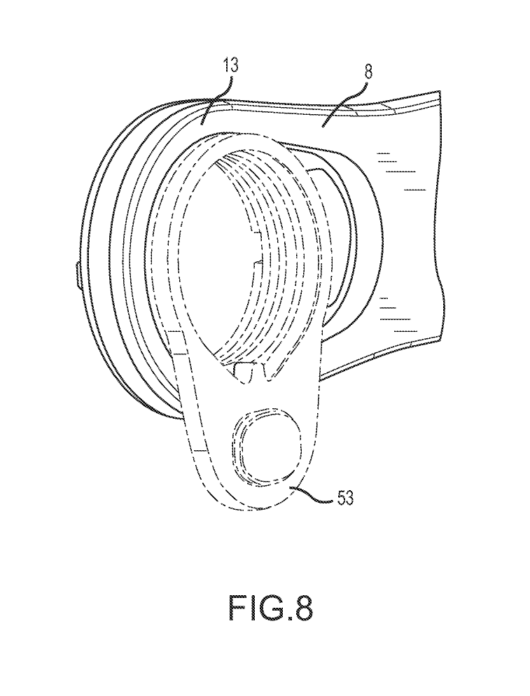

Referring to FIGS. 5, 6, 7, and 8, shown is the aperture 2 engaged with the castle nut 60 on the surround side 8. FIG. 5 shows the wrench 1 engaged with a partially assembled weapon, including carbine buffer tube or carbine receiver extension 50, lower receiver 52, and end plate 53. The end plate 53 is substantially flat on the rear surface facing the wrench 1, and in some embodiments may be a standard CAR-15 or M4 type end plate. FIG. 7 shows how three of castle nut indentations 61 are engaged with the raised elements 4 of the prongs 3. Additionally, the aperture socket interior 5 surrounds a majority of a circumference of the castle nut 60 in a mostly enclosed circle. This provides contact surface area beyond just the surface between the raised elements 4 and castle nut indentations 61. As shown in FIG. 8, from the front (surround) side 8, the face 13 is substantially flush with the end plate 53. This engagement configuration is possible because the end plate 53 is substantially flat. This engagement configuration is beneficial for providing maximum contact surface area, which decreases the likelihood of slipping.

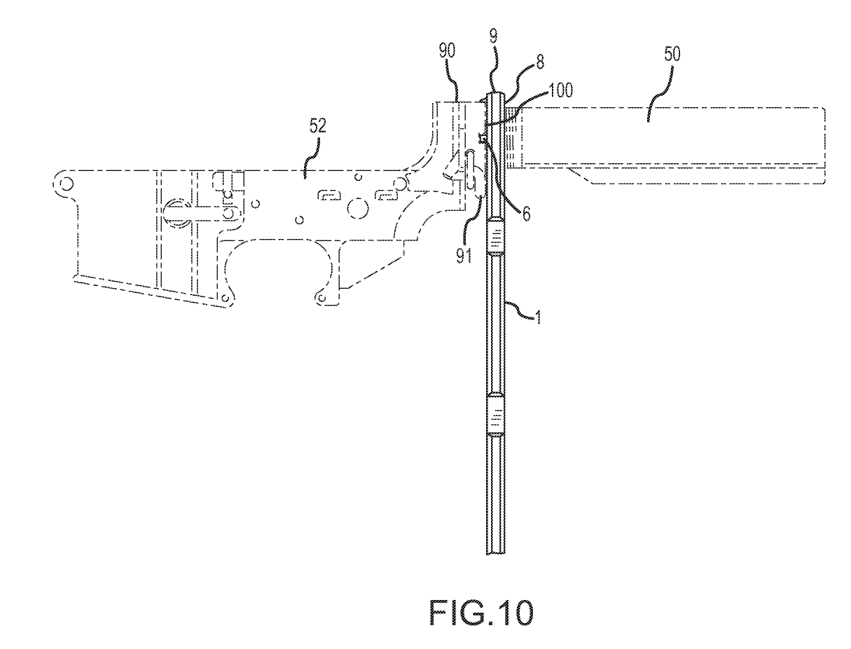

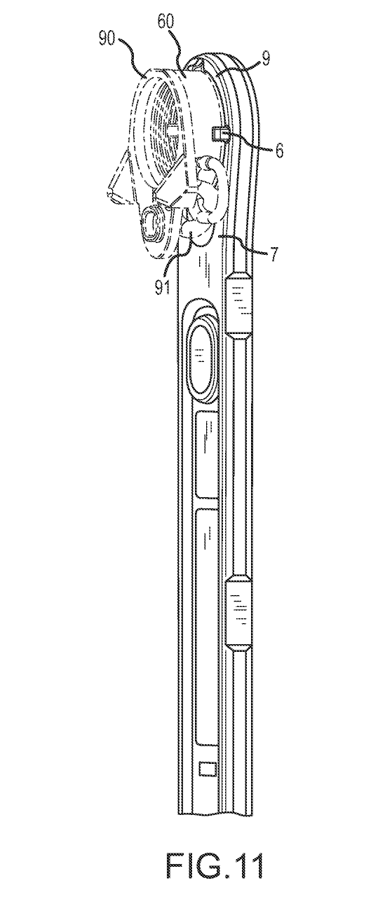

FIGS. 9, 10, and 11 show the wrench 1 engaged with the castle nut 60 on the protrusion side 9. FIG. 9 is a rear perspective view including a partially assembled weapon with the carbine buffer tube or carbine receiver extension 50, the castle nut 60, the accessory end plate 90, and the lower receiver 52. Some embodiments of an accessory end plate 90 are described in detail in commonly-assigned U.S. Pat. No. 8,596,504, the entire contents of which are incorporated herein by reference. FIG. 10 is a side view of FIG. 9, which shows that the accessory end plate 90 has an accessory attachment area 91 which extends past the depth of a standard receiver end plate, and nearly the depth of castle nut 60. The accessory attachment area 91 makes it difficult to engage the castle nut 60 with currently-available partially surrounded castle nut wrenches, which also limit the amount of rotation the wrench can provide with a single stroke. In the case of fully-surrounded designs, the accessory attachment area 91 makes it generally impossible to engage and rotate the castle nut 60 with the surround side 8 of the aperture 2, or with any castle nut wrench which surrounds the castle nut in whole or in part. In the illustrated embodiment, the particular accessory attachment area 91 has a bar to which a sling for a firearm can be attached. This bar protrudes from the end of the accessory end plate 90 out towards the receiver extension 50, which would impede the rotation of a wrench that surrounds the outer circumference of the castle nut. To overcome this challenge, the protruding sections 6 of the prongs 3 engage the castle nut indentations 61 rather than an entire arced aperture of a wrench enveloping the castle nut. In this way, the face 7 of protrusion side 9 sits flush with a rear face 100 of the castle nut 60, and wrench 1 can rotate without impinging on the bar of the accessory attachment area 91 (see also FIG. 11).

The above descriptions show how a user could remove a factory-attached castle nut with surround side 8, as shown in FIGS. 5, 6, 7, and 8, and then install an accessory end plate and reattach the castle nut with the protrusion side 9, when rotation around the accessory end plate is necessary. Such a tool has become necessary with the recent advent of accessory end plates with depths extending to and beyond the rear face of the castle nut. The overall design described herein provides three tools with maximum functionality for each of their uses on one end of a wrench. By placing these three tools on the very end of a wrench, maximum torque for each tool is achieved.

The embodiment described herein allows the opposite end of the wrench to be available for one or more different firearm servicing tools. In one particular embodiment, the opposite end has two barrel nut wrenches. Two-sided barrel nut wrenches are known in the art. However, wrenches containing the two kinds of castle nut wrenches, plus the flash hider wrench, plus the two-sided barrel nut wrench, each feature being at the end of one wrench, are not known.

What is claimed is:

1. A wrench for performing gunsmithing operations, comprising:
a first end having an aperture having a first castle nut interface shaped to engage a castle nut, a second castle nut interface shaped to engage the castle nut, and a flash hider interface; wherein the first castle nut interface comprises a substantially cylindrical wall section shaped to surround a portion of an outer surface of the castle nut, the cylindrical wall section having a plurality of raised elements extending inwardly for engaging a plurality of indentations in the castle nut; and wherein the second castle nut interface comprises a substantially flat face, the flat face having a plurality of protrusions extending from the flat face for engaging the plurality of indentations in the castle nut; and
a second end.

2. The wrench of claim 1, wherein:
the second end comprises a barrel nut interface.

3. The wrench of claim 1, wherein:
the second end comprises a two-sided barrel nut interface.

4. The wrench of claim 1, wherein:
the flash hider interface comprises a stepped passage extending through the wrench, the stepped passage having a flash hider cutout portion extending from a first face of the wrench to a depth of the stepped passage, and a clearance portion extending from the flash hider cutout portion through a second face of the wrench,
the flash hider cutout portion having two opposing flat sections shaped to engage two opposing surfaces on the flash hider.

5. The wrench of claim 4, wherein:
the flash hider cutout portion has a rounded portion shaped to engage a rounded surface on the flash hider.

6. The wrench of claim 4, wherein:
the first face is the flat face of the wrench.

7. The wrench of claim 1, wherein:
the wrench has a second face substantially opposing the flat face; and
the aperture has a receiver end plate interface comprising a recess in the second face, the recess further shaped to allow the flash hider to clear the receiver end plate interface when the flash hider is engaged with the flash hider cutout portion.

8. A wrench for performing gunsmithing operations, comprising:
a first end having an integrated two-sided castle nut and flash hider wrench aperture, the aperture having a plurality of raised elements for engaging indentations in a castle nut, each of the raised elements extending at least one of inwardly from a wall section of the aperture and upwardly from a first face of the wrench, the aperture further having a flash hider cutout portion; and
a second end having a tool interface.

9. The wrench of claim 8, wherein:
the tool interface in the second end comprises a two-sided barrel nut interface.

10. The wrench of claim 8, wherein:
the aperture comprises one of:
(a) a flash hider cutout portion extending from a first face of the wrench to one of a first depth of the aperture and a second face of the wrench, the flash hider cutout portion having two opposing flat sections shaped to engage two opposing surfaces on the flash hider; and
(b) a flash hider cutout portion extending from a second face of the wrench to one of a first depth of the aperture and the first face of the wrench, the flash hider cutout portion having two opposing flat sections shaped to engage two opposing surfaces on the flash hider.

11. The wrench of claim 10, wherein:
the flash hider cutout portion has a rounded portion shaped to engage a rounded surface on the flash hider.

12. The wrench of claim 10, wherein:
the flash hider portion extends from the first face; and
the raised elements extend outward from the first face of the wrench.

13. The wrench of claim 8, wherein:
the flash hider cutout portion extends to a first depth of the aperture from one of the first face of the wrench and a second face of the wrench; and
the aperture comprises a clearance portion extending from the flash hider cutout portion to the other of the first face and the second face of the wrench, the clearance portion shaped to allow the flash hider to clear the clearance portion when the flash hider is engaged with the flash hider cutout portion.

14. The wrench of claim 8, wherein:
the wrench has a second face substantially opposing the first face; and
the aperture further comprises a receiver end plate interface having a recess in the second face of the wrench, recess further positioned to allow the flash hider to clear the receiver end plate interface when the flash hider is engaged with the flash hider cutout portion.

15. A wrench for performing gunsmithing operations, comprising:
a first end having an aperture, the aperture extending through two faces of the wrench and having a plurality of raised elements for engaging indentations in a castle nut, the raised elements extending at least one of inwardly from a substantially cylindrical wall section of the aperture and outward from one of the two faces of the wrench, the aperture further having a flash hider interface having two opposing walls; and
a second end.

16. The wrench of claim 15, wherein:
the second end of the wrench comprises a two-sided barrel nut interface.

17. The wrench of claim 15, wherein:
the flash hider interface extends from one of the two faces of the wrench to one of a first depth of the aperture and the other one of the two faces of the wrench.

18. The wrench of claim 17, wherein:
the flash hider interface has a rounded portion shaped to engage a rounded surface on the flash hider.

19. The wrench of claim 17, wherein:
the flash hider interface and the raised elements extend from the same one of the two faces of the wrench.

20. The wrench of claim 17, wherein:
the flash hider interface extends to a first depth of the aperture from one of the first face of the wrench and the second face of the wrench; and
the aperture comprises a receiver end plate interface extending from the flash hider interface to the other of the first face and the second face of the wrench, the receiver end plate interface shaped engage a receiver end plate and to allow the flash hider to clear the receiver end plate interface when the flash hider is engaged with the flash hider interface.
